(19) United States
(12) Patent Application Publication
(10) Pub. No.: US 2021/0322236 A1
(43) Pub. Date: Oct. 21, 2021

(54) BED WITH ACTUATABLE MATTRESS SUPPORT PLATFORM AND METHOD OF ACTUATING SUCH A BED

(71) Applicant: Invacare International GmbH, Witterswil (CH)

(72) Inventors: Kirsten GRØNNEGAARD-KIELER, Rungsted Kyst (DK); Joaquim FERREIRA, Santa Maria Da Feira (PT); Francisco TAVEIRA, Porto (PT); Henrique GONÇALVES, Alfena (PT)

(21) Appl. No.: 17/168,919

(22) PCT Filed: Aug. 5, 2019
(86) PCT No.: PCT/IB2019/056638

§ 371 Date: Feb. 5, 2021

(30) Foreign Application Priority Data
Aug. 7, 2018 (EP) 18187848.9

(51) Int. Cl. A61G 7/015; A61G 7/018; A61G 7/012; A61G 7/005

(52) U.S. Cl. CPC A61G 7/015; A61G 7/018; A61G 2200/34; A61G 7/005; A61G 2200/327; A61G 7/012

(57) ABSTRACT

The bed includes a support structure and an actuatable mattress support platform, which actuatable mattress support platform has a reclinable back section and an actuatable leg section. The actuatable leg section includes a reclinable thigh section and a reclinable lower-leg section that are adapted to move in conjunction with one another. The reclinable back section and actuatable leg section are actuatable to adjust a configuration of the actuatable mattress support platform and change the configuration of the actuatable mattress support platform from a substantially flat configuration to a sitting configuration, or vice versa. During a first actuation phase, exclusively the actuatable leg section is actuated to raise the actuatable leg section with respect to the support structure, thereby bringing the actuatable leg section to a first intermediate position with respect to the support structure. During a subsequent second actuation phase, both the reclinable back section and the actuatable leg section are actuated to respectively raise the reclinable back section and raise further the actuatable leg section with respect to the support structure, thereby bringing the actuatable leg section to a second intermediate position with respect to the support structure higher than the first intermediate position. During a subsequent third actuation phase, both the reclinable back section and the actuatable leg section are actuated to respectively raise further the reclinable back section and lower the actuatable leg section with respect to the support structure, thereby bringing the reclinable back section and actuatable leg section to selected final positions with respect to the support structure in which the reclinable back section and the actuatable leg section are both raised with respect to the support structure.

### TECHNICAL FIELD

The present invention generally relates to a bed, in particular a medical or hospital bed, of the type comprising an actuatable mattress support platform intended to receive a mattress, which actuatable mattress support platform can be configured to take various configurations, including a substantially flat configuration and a sitting configuration. The present invention also generally relates to a method of actuating such a bed.

### BACKGROUND OF THE INVENTION

Beds of the aforementioned type are already known as such in the art.

International (PCT) Publication No. WO 02/17846 A1 for instance discloses a bed comprising an actuatable mattress support platform that is divided into a plurality of individual sections for supporting a patient's head, back, buttocks, thighs, legs and feet. A plurality of actuators are provided for selectively raising or lowering the individual sections under the action of a control unit and thereby adjust a configuration of the actuatable mattress support platform. The control unit is in particular adapted to control operation of the actuators to change the configuration of the actuatable mattress support platform from a substantially flat configuration to a sitting configuration, or vice versa.

International (PCT) Publication No. WO 2007/096828 A1 discloses another bed comprising a reconfigurable actuatable mattress support platform wherein articulations between the individual sections of the actuatable mattress support platform can be changed so as to adjust the respective length of each section of the actuatable mattress support platform.

European Patent Publication No. EP 2 772 237 A2 discloses yet another bed comprising an actuatable mattress support platform that can be changed from a substantially flat configuration to a sitting configuration.

International (PCT) Publication No. WO 97/20534 A1 discloses a bed likewise comprising an actuatable mattress support platform that can be changed form a substantially flat configuration to a sitting configuration, as well as other configurations.

International (PCT) Publication No. WO 95/19755 A1 and U.S. Pat. No. 5,479,666 A disclose a hospital bed that is convertible to a chair for patient egress from the foot end of the bed. Another similar foot egress chair bed is also disclosed in U.S. Pat. No. 5,715,548 A.

European Patent Publication No. EP 2 308 439 A1 discloses a bed that is likewise convertible to a chair for patient egress from the foot end of the bed. According to European Patent Publication No. EP 2 308 439 A1, a reclinable back section of the bed is configured to be movable forward, towards the foot end of the bed.

International (PCT) Publication No. WO 2017/183670 A1 discloses a reclining bed which reduces the burden imposed on the body of a recumbent person when raising the upper half of the body, which reclining bed comprises a segmented back section comprising a reclinable back-receiving base that receives a prescribed part of the recumbent person's upper half body that is lower than the shoulders and a reclinable shoulder-receiving base for receiving at least the shoulders and a portion higher than the shoulders of the recumbent person's body.

An issue arises when switching the configuration of the aforementioned beds from a substantially flat configuration to a sitting configuration from the point of view of comfort for the patient. Typically, the reclinable back section and actuatable leg section are actuated simultaneously when switching from the substantially flat configuration to the sitting position, which may potentially cause stress on the patient's hamstrings, undesired sliding of the patient on the mattress surface, and increase pressure in the region of the patient's lower back section.

European Patent Publication No. EP 1 346 671 A1 discloses a method of adjustment of a base structure for a bed or the like, which base structure comprises a reclinable back section and an actuatable leg section, including a reclinable thigh section and a reclinable lower-leg section that are adapted to move in conjunction with one another. The reclinable back section and actuatable leg section can be actuated independently of one another to change a configuration of the base structure from a substantially flat configuration to a sitting configuration, or vice versa. According to European Patent Publication No. EP 1 346 671 A1, upon changing the configuration of the base structure from the substantially flat configuration to the sitting configuration, the reclinable back section and the actuatable leg section are respectively brought to final positions in which the reclinable back section is raised and the actuatable leg section is returned to a fully flat configuration. This is specifically contemplated with a view to avoid discomfort for the patient due to the increase of pressure and compression in the patient's abdominal region. This approach is neither satisfying nor desirable, however, since nothing prevents the patient from sliding on the mattress surface in the sitting configuration.

There is therefore a need for an improved solution.

### SUMMARY OF THE INVENTION

A general aim of the invention is to provide a bed and method of actuating a bed that improve comfort for the patient during reconfiguration of the actuatable mattress support platform from a substantially flat configuration to a sitting position, and vice versa, and especially prevent as much as possible sliding of the patient on the mattress surface during reconfiguration of the bed.

A further aim of the invention is to provide such a bed and actuation method that limit stress on the patient's body, especially on the patient's hamstrings, as well as reduce pressure in the region the patient's lower back section.

Yet another aim of the invention is to provide such a solution that is simple and robust to implement and does require complexification of the actuatable mattress support platform.

These aims are achieved thanks to the solutions defined in the claims.

In accordance with the invention, there is provided a bed, in particular a medical or hospital bed, as defined in claim 1, namely a bed comprising a support structure and an actuatable mattress support platform intended to receive a mattress and mounted on the support structure, which actuatable mattress support platform comprises a reclinable back section and an actuatable leg section. The actuatable leg section includes a reclinable thigh section and a reclinable lower-leg section that are adapted to move in conjunction with one another. The bed further comprises a first actuating mechanism adapted to raise or lower the reclinable back section with respect to the support structure, a second actuating mechanism adapted to raise or lower the actuatable leg section with respect to the support structure, and a control unit in operative communication with the first and second actuating mechanisms to adjust a configuration of the actuatable mattress support platform. The control unit is adapted to control operation of the first and second actuating mechanisms to change the configuration of the actuatable mattress support platform from a substantially flat configuration to a sitting configuration, or vice versa. According to the invention, the control unit is adapted to change the configuration of the actuatable mattress support platform from the substantially flat configuration to the sitting configuration in accordance with the following sequence of actuation phases:

(i) a first actuation phase during which the control unit operates exclusively the second actuating mechanism to raise the actuatable leg section with respect to the support structure, thereby bringing the actuatable leg section to a first intermediate position with respect to the support structure;

(ii) a second actuation phase during which the control unit operates both the first and second actuating mechanisms to respectively raise the reclinable back section and raise further the actuatable leg section with respect to the support structure, thereby bringing the actuatable leg section to a second intermediate position with respect to the support structure higher than the first intermediate position; and

(iii) a third actuation phase during which the control unit operates both the first and second actuating mechanisms to respectively raise further the reclinable back section and lower the actuatable leg section with respect to the support structure, thereby bringing the reclinable back section and actuatable leg section to selected final positions with respect to the support structure in which the reclinable back section and the actuatable leg section are both raised with respect to the support structure.

By way of preference, the bed further comprises a third actuating mechanism in operative communication with the control unit and adapted to change an angle of inclination of the support structure, and thus of the actuatable mattress support platform as a whole, and the control unit is further adapted, upon changing the configuration of the actuatable mattress support platform from the substantially flat configuration to the sitting configuration, to operate the third actuating mechanism to incline the support structure forward and bring the actuatable mattress support platform to a reverse Trendelenburg sitting position.

The actuatable mattress support platform can in particular be brought to the reverse Trendelenburg sitting position once the actuatable leg section has been brought to the selected final position with respect to the support structure.

Furthermore, the bed may advantageously be designed in such a way that an axis of inclination of the support structure is located in the vicinity of a head portion of the bed.

According to a preferred embodiment of the invention, the reclinable back section is designed as a separate section that is independent from other sections of the actuatable mattress support platform. In this context, the reclinable back section may in particular be movable towards or away from the other sections of the actuatable mattress support platform, the control unit being adapted to operate the first actuating mechanism, during the second and third actuation phases, in such a way that a proximal end of the reclinable back section is moved away from the other sections of the actuatable mattress support platform as the reclinable back section is being raised. By way of preference, the reclinable back section is articulated at one end on the support structure via an articulated linkage and the first actuating mechanism comprises an actuator connected to the reclinable back section via a coupling to change an angle of inclination of the reclinable back section with respect to the support structure and to move the proximal end of the reclinable back section towards or away from the other sections of the actuatable mattress support platform.

According to an advantageous embodiment of the invention, the reclinable thigh section is articulated onto the support structure. Preferably, the actuatable mattress support platform further includes a buttocks section, which buttocks section is fixedly secured onto the support structure or forms an integral part of the support structure.

According to yet another advantageous embodiment of the invention, the reclinable lower-leg section is articulated onto the thigh section and the actuatable leg section comprises an articulated guide provided on a portion of the lower-leg section, which articulated guide is adapted to slide along the support structure upon raising or lowering the actuatable leg section.

In accordance with the invention, there is also provided a method of actuating a bed as defined in independent claim 17, namely a method of actuating a bed comprising a support structure and an actuatable mattress support platform intended to receive a mattress and mounted on the support structure, which actuatable mattress support platform comprises a reclinable back section and an actuatable leg section, which actuatable leg section includes a reclinable thigh section and a reclinable lower-leg section that are adapted to move in conjunction with one another. The method comprises actuating the reclinable back section and actuatable leg section to adjust a configuration of the actuatable mattress support platform and change the configuration of the actuatable mattress support platform from a substantially flat configuration to a sitting configuration, or vice versa. According to the invention, the method comprises actuating the reclinable back section and actuatable leg section, upon changing the configuration of the actuatable mattress support platform from the substantially flat configuration to the sitting configuration, in accordance with the following sequence of actuation phases:

(i) a first actuation phase during which exclusively the actuatable leg section is actuated to raise the actuatable leg section with respect to the support structure, thereby bringing the actuatable leg section to a first intermediate position with respect to the support structure;

(ii) a second actuation phase during which both the reclinable back section and the actuatable leg section are actuated to respectively raise the reclinable back section and raise further the actuatable leg section with respect to the support structure, thereby bringing the actuatable leg section to a second intermediate position with respect to the support structure higher than the first intermediate position; and

(iii) a third actuation phase during which both the reclinable back section and the actuatable leg section are actuated to respectively raise further the reclinable back section and lower the actuatable leg section with respect to the support structure, thereby bringing the reclinable back section and actuatable leg section to selected final positions with respect to the support structure in which the reclinable back section and the actuatable leg section are both raised with respect to the support structure.

By way of preference, the method further comprises the step of actuating the support structure to change an angle of inclination of the support structure, and thus of the actuatable mattress support platform as a whole, the support structure being actuated, upon changing the configuration of the actuatable mattress support platform from the substantially flat configuration to the sitting configuration, to incline the support structure forward and bring the actuatable mattress support platform to a reverse Trendelenburg sitting position.

The actuatable mattress support platform can in particular be brought to the reverse Trendelenburg sitting position once the actuatable leg section has been brought to the selected final position with respect to the support structure.

Furthermore, actuation of the support structure may be such that an axis of inclination of the support structure is located in the vicinity of a head portion of the bed.

In addition, and by way of preference, actuation of the reclinable back section includes changing an angle of inclination of the reclinable back section with respect to the support structure as well as moving the reclinable back section towards or away from other sections of the actuatable mattress support platform.

In accordance with a particularly preferred embodiment of the bed and method of the invention, the first intermediate position of the actuatable leg section is a position in which an angle of inclination of the reclinable thigh section with respect to the support structure is increased to an angle of approximately 20° to 30°, in particular an angle of the order of 25°, the second intermediate position of the actuatable leg section is a position in which the angle of inclination of the reclinable thigh section with respect to the support structure is increased to an angle of approximately 45° to 55°, in particular an angle of the order of 49°, and the final position of the actuatable leg section is a position in which the angle of inclination of the reclinable thigh section with respect to the support structure is decreased to an angle of approximately 30° to 40°, in particular an angle of the order of 35°. In this context, the final position of the reclinable back section may in particular be a position in which an angle of inclination of the reclinable back section with respect to the support structure is increased to an angle of approximately 45° to 55°, in particular an angle of the order of 50°.

Further advantageous embodiments of the invention form the subject-matter of the dependent claims and are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIGS. 1A and 1B are perspective views of a bed in accordance with a preferred embodiment of the present invention, which bed comprises a support structure and an actuatable mattress support platform intended to receive a mattress (not shown) and mounted on the support structure;

FIG. 2A is a side view of the bed of FIGS. 1A and 1B showing the actuatable mattress support platform in a substantially flat configuration;

FIG. 2B is a side view of the bed of FIGS. 1A and 1B showing a first actuation phase of the actuatable mattress support platform that is initiated upon changing the configuration of the actuatable mattress support platform from the substantially flat configuration depicted in FIG. 2A to a sitting configuration;

FIG. 2C is a side view of the bed of FIGS. 1A and 1B showing a second actuation phase of the actuatable mattress support platform that is initiated following the first actuation phase depicted in FIG. 2B;

FIG. 2D is a side view of the bed of FIGS. 1A and 1B showing a third actuation phase of the actuatable mattress support platform that is initiated following the second actuation phase depicted in FIG. 2C;

FIG. 2E is a side view of the bed of FIGS. 1A and 1B showing a final configuration of the actuatable mattress support platform relative to the support structure, at the end of the third actuation phase depicted in FIG. 2D; and

FIG. 2F is a side view of the bed of FIGS. 1A and 1B showing a preferred reverse Trendelenburg sitting configuration of the actuatable mattress support platform resulting from forward inclination of the support structure with respect to the floor following completion of the third actuation phase depicted in FIG. 2E.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the bed and actuation method disclosed herein.

As described herein, when two or more parts or components are described as being connected or coupled to one another, they can be so connected or coupled directly to each other or through one or more intermediary parts.

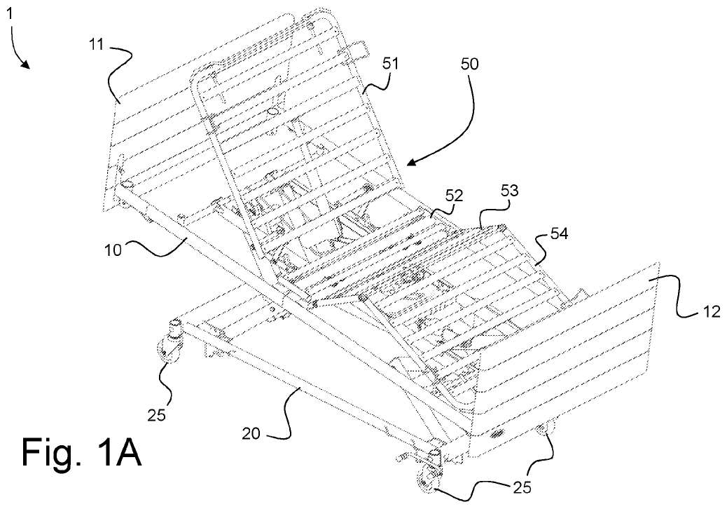

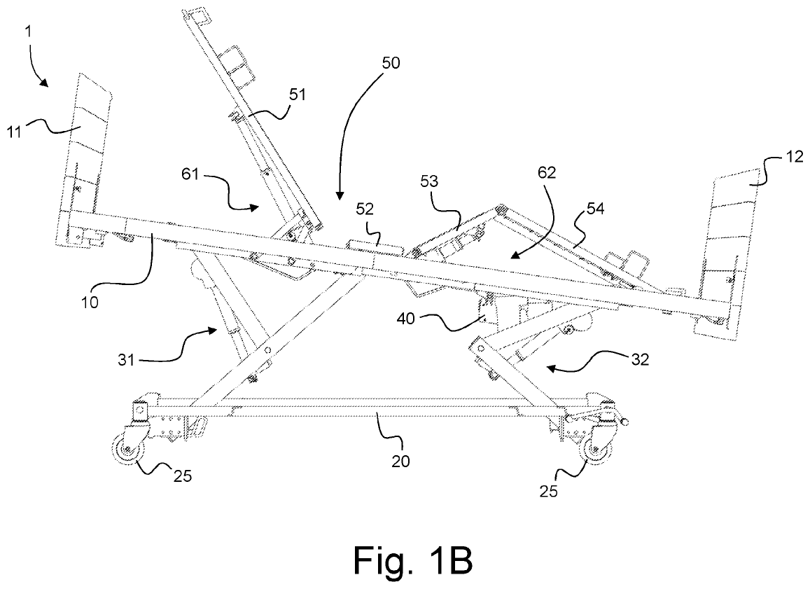

Referring to FIGS. 1A and 1B, there is shown a medical or hospital bed 1 in accordance with a preferred embodiment of the invention. The bed 1 includes a support structure 10 (here taking the shape of a bed frame) and an actuatable mattress support platform 50 intended to receive a mattress (not shown), which actuatable mattress support platform 50 is mounted on the support structure 10.

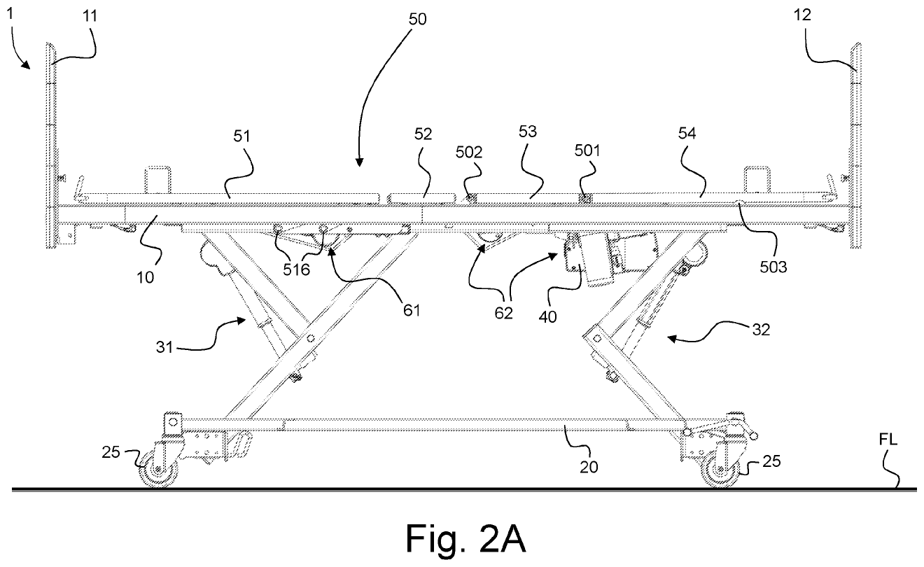

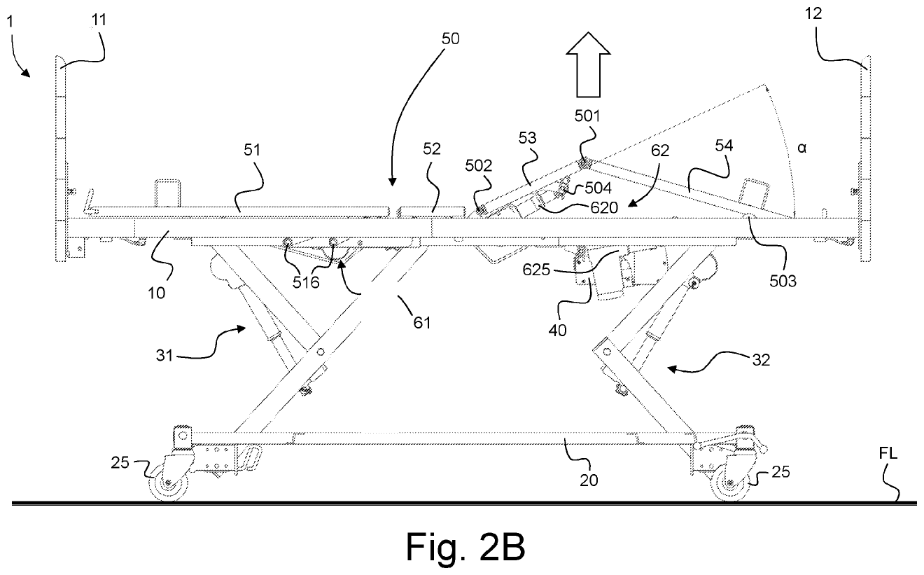

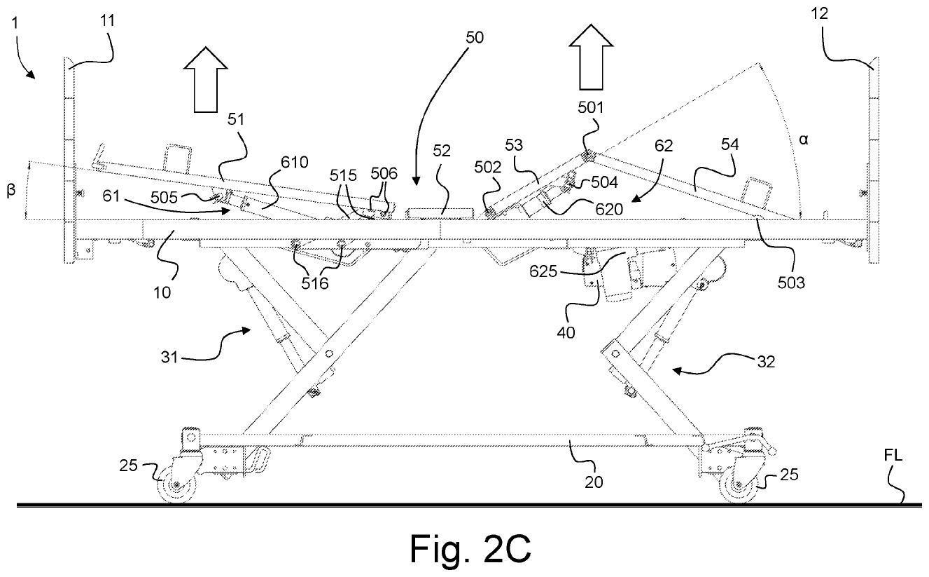

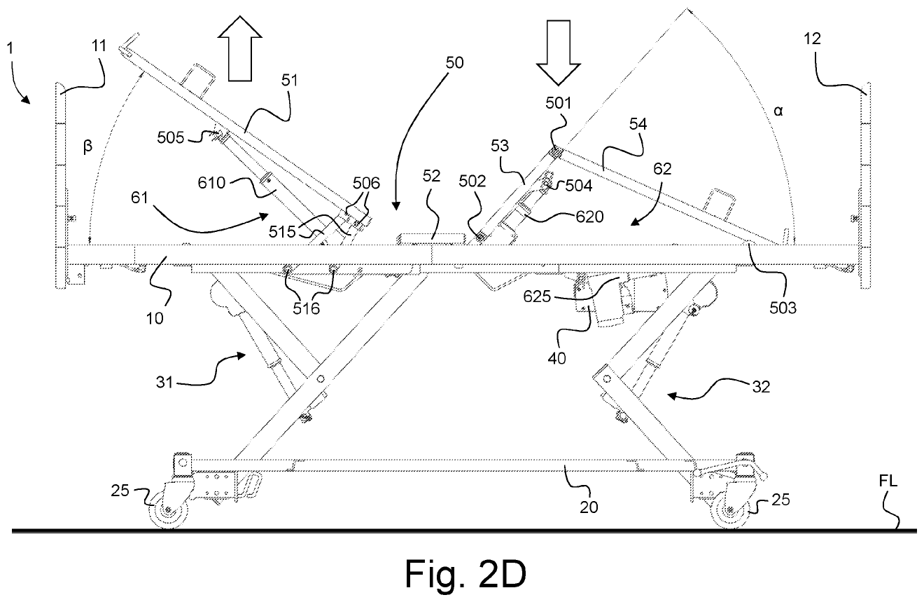

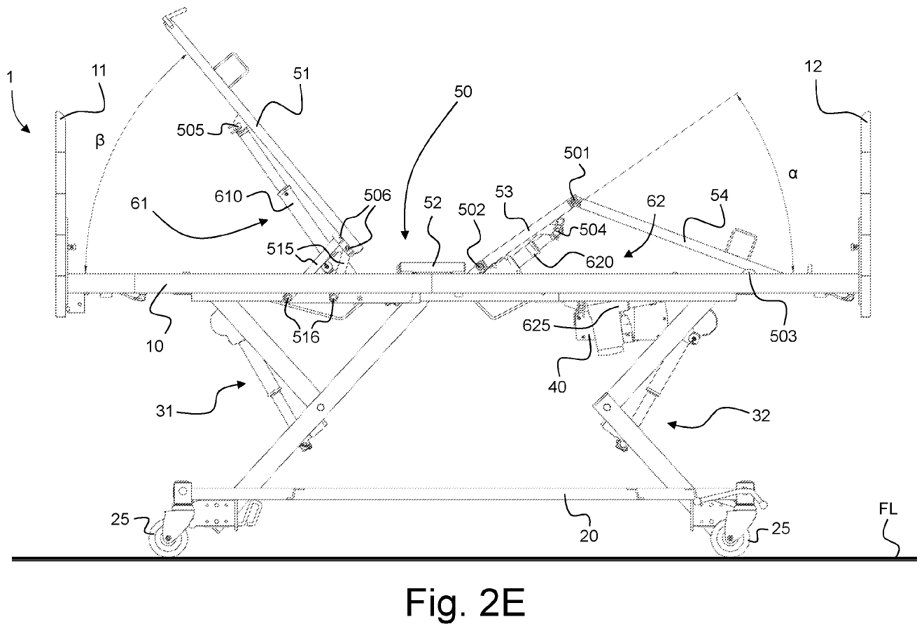

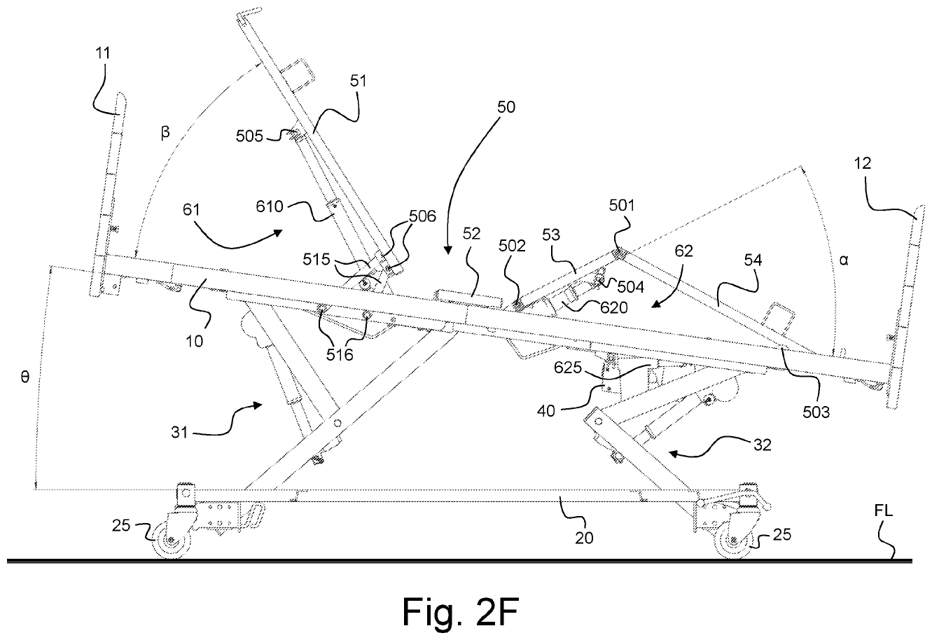

The actuatable mattress support platform 50 includes a plurality of sections 51, 52, 53, 54, at least part of which are actuatable to change their position with respect to the support structure 10. More precisely, the actuatable mattress support platform 50 comprises at least a reclinable back section 51, which is intended to receive and support a portion of the mattress corresponding to the back of a patient resting on the mattress, and an actuatable leg section 53/54, which is intended to receive and support a portion of the mattress corresponding to the patient's legs. The actuatable leg section 53/54 includes a reclinable upper section, or thigh section, 53 and a reclinable lower section, or lower-leg section 54, that are adapted to move in conjunction with one another. In the illustrated example, the reclinable lower-leg section 54 is preferably articulated onto the thigh section 53 via a corresponding articulation (designated by reference numeral 501 in FIGS. 2A-2F), but it should be appreciated that such articulation is not absolutely necessary and that the reclinable thigh section 53 and reclinable lower-leg section 54 could alternatively be designed as separate actuatable sections.

In the illustrated example, the actuatable mattress support platform 50 further includes a buttocks section 52 that is fixedly secured onto the support structure 10. This buttocks section 52 could alternatively be an integral part of the support structure 10. Furthermore, the reclinable thigh section 53 is preferably articulated onto the support structure 10 via a corresponding articulation (designated by reference numeral 502 in FIGS. 2A-2F).

Actuation of the reclinable back section 51 and of the actuatable leg section 53/54 is performed by means of first and second actuating mechanism 61, 62, respectively, which are in operative communication with a suitable control unit 40 that can be operated by the patient and/or a caregiver via an adequate control terminal (not shown). The first actuating mechanism 61 is adapted to raise or lower the reclinable back section 51 with respect to the support structure 10 and comprises an actuator 610 coupled to the reclinable back section 51, while the second actuating mechanism 62 is adapted to raise or lower the actuatable leg section 53/54 with respect to the support structure 10 and comprises an actuator 620 coupled to the reclinable thigh section 53. The second actuating mechanism 62 further comprises another actuator 625 coupled to the reclinable lower-leg section 54. In the following, reference signs α and β will be used to refer respectively to an angle of inclination of the reclinable thigh section 53 and an angle of inclination of the reclinable back section 51 with respect to the support structure 10.

The aforementioned control unit 40 is in particular adapted to control operation of the first and second actuating mechanisms 61, 62 to change the configuration of the actuatable mattress support platform 50 from a substantially flat configuration to a sitting configuration, or vice versa. The control unit 40 could implement further functions such as control of the height of the bed and individual control of the reclinable back section 51 and actuatable leg section 53/54.

Bed end panels 11, 12 are provided at both ends of the support structure 10 at head and foot portions, respectively, of the bed 1. These bed end panels 11, 12 may be made of wood, melamine or any other suitable material. Side panels could likewise be provided on either side of the bed 1 if desired, as well as side rails, which additional features are known as such in the art.

In the illustrated example, the bed 1 further includes a base frame 20 equipped with a plurality of caster wheels 25 that provide rolling support for the base frame 20, which base frame 20 preferably supports the support structure 10 via a third actuating mechanism comprising a pair of actuating devices 31, 32. The actuating mechanism 31/32 is adapted to change an angle of inclination (designated by reference sign 8) of the support structure 10—and thus of the actuatable mattress support platform 50 as a whole—with respect to the floor.

In the illustrated example, actuating devices 31, 32 are mechanically independent and are respectively provided in the vicinity of the head and foot portions of the bed 1. Actuating devices 31, 32 are likewise in operative communication with the control unit 40 to allow adjustment of the angle of inclination θ of the support structure 10.

Suitable structures to control and adjust the angle of inclination θ of the support structure 10 are known as such in the art and do not therefore need to be discussed in great detail. Examples thereof are for instance disclosed in U.S. Pat. Nos. 5,161,274 A and 5,205,004 A, which publications are incorporated herein by reference (see also International PCT Publication No. WO 01/47340 A2). In the context of the present invention, it suffices to make use of any adequate actuation mechanism adapted to change an angle of inclination of the support structure 10 with respect to the floor.

The bed shown in FIGS. 1A and 1B is depicted in a preferred sitting configuration, with sections 51, 53, 54 of the actuatable mattress support platform 50 being raised to desired sitting positions under the action of the first and second actuating mechanisms 61, 62. Furthermore, in the illustrated example, the support structure 10 is inclined forward under the action of the third actuating mechanism 31/32 to bring the actuatable mattress support platform 50 to a so-called reverse Trendelenburg sitting position, i.e. with the foot portion of the bed 1 being lowered with respect to the head portion of the bed 1.

According to the invention, the control unit 40 is adapted to change the configuration of the actuatable mattress support platform 50 from a substantially flat configuration to a desired sitting configuration in accordance with a particular sequence of actuation phases that will now be described with reference to a preferred embodiment illustrated by FIGS. 2A-2F.

FIG. 2A is a side view of the bed of FIGS. 1A and 1B showing the actuatable mattress support platform 50 in a substantially flat configuration. In the substantially flat configuration depicted in FIG. 2A, the actuatable sections 51, 53, 54 of the actuatable mattress support platform 50 are basically positioned so as to be substantially parallel to the support structure 10. FIG. 2A further shows the articulation 501 between the reclinable thigh section 53 and reclinable lower-leg section 54 and the articulation 502 between the reclinable thigh section 53 and support structure 10. Reference numeral 503 designates an articulated guide of lower-leg section 54 that is adapted to slide along the support structure 10 upon raising or lowering the actuatable leg section 53/54, as illustrated by FIGS. 2B-2F, which articulated guide 503 is coupled to actuator 625 of actuating mechanism 62. Reference numerals 504 and 505 respectively designate a coupling of reclinable thigh section 53 to actuator 620 of actuating mechanism 62 and a coupling of reclinable back section 51 to actuator 610 of actuating mechanism 61.

During a first actuation phase, as illustrated by FIG. 2B, the control unit 40 operates exclusively the second actuating mechanism 62 to raise the actuatable leg section 53/54 with respect to the support structure 10. By way of preference, this first actuation phase is carried out until the actuatable leg section 53/54 is brought to a first intermediate position where the angle of inclination α of the reclinable thigh section 53 with respect to the support structure 10 is increased to an angle of approximately 20° to 30°. In the illustrated example, this angle is advantageously selected to be of the order 25°.

During a second actuation phase, as illustrated by FIG. 2C, that is initiated following the first actuation phase depicted in FIG. 2B, the control unit 40 operates both the first and second actuating mechanisms 61, 62 to respectively raise the reclinable back section 51 and raise further the actuatable leg section 53/54 with respect to the support structure 10. By way of preference, this second actuation phase is carried out until the actuatable leg section 53/54 is brought to a second intermediate position, higher than the first intermediate position, where the angle of inclination a of the reclinable thigh section 53 with respect to the support structure 10 is increased to an angle of approximately 45° to 55°. In the illustrated example, this angle is advantageously selected to be of the order 49°. At this point in time, the reclinable back section 51 has been elevated to an intermediate position in which the angle of inclination β of the reclinable back section 51 with respect to the support structure 10 is of the order e.g. of 35°.

During a third actuation phase, as illustrated by FIG. 2D, that is initiated following the second actuation phase depicted in FIG. 2C, the control unit 40 operates both the first and second actuating mechanisms 61, 62 to respectively raise further the reclinable back section 51 and lower the actuatable leg section 53/54 with respect to the support structure 10. This third actuation phase ends once the reclinable back section 51 and actuatable leg section 53/54 have been brought to selected final positions with respect to the support structure 10, as depicted by FIG. 2E, namely positions in which the reclinable back section 51 and the actuatable leg section 53/54 are both raised with respect to the support structure 10. By way of preference, the final position of the actuatable leg section 53/54 is a position in which the angle of inclination α of the reclinable thigh section 53 with respect to the support structure 10 is decreased to an angle of approximately 30° to 40°. In the illustrated example, this angle is advantageously selected to be of the order 35°. The final position of the reclinable back section 51 is a position in which the angle of inclination β of the reclinable back section 51 with respect to the support structure 10 is preferably increased to an angle of approximately 45° to 55°. This angle is advantageously selected to be of the order of 50°.

In accordance with a particularly preferred embodiment of the invention, the control unit 40 is further adapted, upon changing the configuration of the actuatable mattress support platform 50 from the substantially flat configuration to the sitting configuration, to operate the third actuating mechanism 31/32 to incline the support structure 10 forward and bring the actuatable mattress support platform 50 to a reverse Trendelenburg sitting position, as depicted by FIG. 2F. This reverse Trendelenburg movement can in particular be carried out once the actuatable leg section has been brought to the selected final position with respect to the support structure 10, namely once the aforementioned actuation phase has been completed. By way of preference, the angle of inclination θ of the support structure 10 in the reverse Trendelenburg sitting position is of the order of 8° with respect to the floor FL.

The reverse Trendelenburg movement could however be carried out at any other appropriate time, for instance during the third actuation phase, it being to be appreciated that the reverse Trendelenburg movement can be carried out independently of the actuation of the mattress support platform 50.

By way of preference, the bed 1 is designed in such a way that an axis of inclination of the support structure 10 is located in the vicinity of a head portion of the bed 1. In other words, the bed 1 is designed so that mainly the foot portion of the bed 1 is lowered during the reverse Trendelenburg movement, which greatly reduces discomfort for the patient as the axis of inclination substantially coincides with the location where the patient's head is situated, reducing perceived movement for the patient, both visually and physiologically.

There are several advantages resulting from the aforementioned bed actuation methodology.

First of all, by raising exclusively the actuatable leg section 53/54 during the first actuation phase, one relieves tension on the patient's hamstrings, thus greatly reducing discomfort for the patient.

Once the patient's hamstrings are relieved as a result of elevation of the actuatable leg section 53/54, the back section 51 can be elevated, together with further elevation of the actuatable leg section 53/54. This ensures proper transition of the patient to an intermediate sitting position. During this second actuation phase, the actuatable leg section 53/54 is brought to its maximum height to prevent the patient from sliding downward on the mattress due to the elevation of the back section 51.

Once the actuatable leg section 53/54 has reached its maximum height at the end of the second actuation phase, the actuatable leg section 53/54 is moved down as the back section 51 continues to move up, which in effect rotates the patient to a sitting position, without sliding on the mattress surface.

Once the thigh section 53 has reached its final position of e.g. 35°, the reverse Trendelenburg movement is carried out until the bed reaches its final sitting position, with the back section 51 and thigh section 53 inclined at respectively 50° and 35° relative to the support structure 10 and the support structure 10 inclined at 8° relative to the floor.

Tests carried out by the Applicant have demonstrated substantial improvements in terms of comfort and pressure relief compared to the known beds and bed actuating methodologies.

By way of preference, the reclinable back section 51 is designed as a separate section that is independent from the other sections 52, 53, 54 of the actuatable mattress support platform 50. More precisely, the reclinable back section 51 is preferably movable towards or away from the other sections 52, 53, 54 of the actuatable mattress support platform 50. Furthermore, the control unit 40 is adapted to operate the first actuating mechanism 61, during the second and third actuation phases, in such a way that a proximal end of the reclinable back section 51 (i.e. the end of the reclinable back section 51 that sits proximate to the buttocks section 52) is moved away from the other sections 52, 53, 54 of the actuatable mattress support platform 50 as the reclinable back section 51 is being raised, as shown in FIGS. 2C-2E. In the preferred embodiment illustrated in FIGS. 2A-2F, the reclinable back section 51 is articulated at one end on the supporting structure 10 via an articulated linkage 506/515/516 and the first actuating mechanism 61 comprises an actuator 610 connected to the reclinable back section 51 via a coupling 505 to change the angle of inclination β of the reclinable back section 51 with respect to the support structure 10 as well as move the proximal end of the reclinable back section 51 towards or away from the other sections 52, 53, 54 of the actuatable mattress support platform 50. Looking at the illustrations of FIGS. 2A-2F, one can see that the reclinable back section 51 is not only inclined but that the proximal end thereof is also moved slightly away from the buttocks section 52 upon changing the configuration of the actuatable mattress support platform 50 from the substantially flat configuration to the sitting configuration. This is advantageous in that this reduces shear and pressure in the lower back section of the patient as the mattress support platform 50 transitions from the substantially flat configuration to the desired sitting position. In the illustrated example, the articulated linkage 506/515/516 comprises first and second arms 515 connected at one end to the reclinable back section 51 via corresponding articulations 506 and at the other end to the support structure 10 via another set of articulations 516.

Various modifications and/or improvements may be made to the above-described embodiments without departing from the scope of the invention as defined by the annexed claims. For instance, any suitable arrangements could be contemplated in order to actuate the mattress support platform and support structure. As far as actuation of the mattress support platform is concerned, any adequate system that allows independent actuation of a reclinable back section and actuatable leg section would be sufficient for the purpose of carrying out the actuation sequence of the invention.

Furthermore, although the embodiments disclosed herein show a bed comprising a pair of mechanically-independent actuating devices to change the angle of inclination of the support structure, other actuating mechanisms could be contemplated in order to allow adjustment of the angle of inclination and carry out the preferred reverse Trendelenburg movement.

In addition, while FIGS. 2A-2F show a transition of the mattress support platform from a completely flat configuration to a sitting configuration, the invention is also applicable in the event of a transition from any other substantially flat configuration, including configurations e.g. where the back section 51 is already slightly raised with respect to the support structure 10. In such event, one could either contemplate to bring the back section 51 down before raising up the actuatable leg section 53/54, or leave the back section 51 where it is during the first actuation phase and start raising the back section 51 from its actual position during subsequent actuation phases. Within the scope of the present invention, it should be appreciated that the relevant actuation sequence can especially be initiated as long the angle of inclination β of the back section 51 with respect to the support structure 10 does not exceed 10° to 20°.

It should likewise be appreciated that the actuatable leg section 53/54 does not necessarily need to be totally flat before initiating the actuation sequence and could already be raised slightly relative to the support structure 10.

In the context of the present invention, the actuatable mattress support platform may be considered to be in a substantially flat configuration as long as angles of inclination α and β do not exceed 20°.

### LIST OF REFERENCE NUMERALS AND SIGNS USED THEREIN

1 bed according to a preferred embodiment of the invention
10 inclinable support structure
11 bed end panel (head portion)
12 bed end panel (foot portion)
20 base frame supporting the inclinable support structure 10 via actuating devices 31, 32
25 caster wheels for rolling support of base frame 20
31 actuating device adapted to raise or lower a head portion of support structure 10 (part of actuating mechanism adapted to change angle of inclination θ of the support structure 10)
32 actuating device adapted to raise or lower a foot portion of support structure 10 (part of actuating mechanism adapted to change inclination θ angle of the support structure 10)
40 control unit in operative communication with first and second actuating mechanisms 61, 62 as well as first and section actuating devices 31, 32
50 actuatable mattress support platform mounted on support structure 10
51 reclinable back section
52 buttocks section (fixedly secured to support structure 10 or forming an integral part thereof)
53 reclinable upper section, or thigh section (part of actuatable leg section)
54 reclinable lower section, or lower-leg section (part of actuatable leg section)
501 articulation between thigh section 53 and lower-leg section 54
502 articulation between thigh section 53 and support structure 10
503 articulated guide of lower-leg section 54 coupled to actuator 625 of actuating mechanism 62 and adapted to slide along support structure 10 upon raising or lowering the actuatable leg section 53/54
504 coupling of thigh section 53 to actuator 620 of actuating mechanism 62
505 coupling of reclinable back section 51 to actuator 610 of actuating mechanism 61
506 articulations between back section 51 and arms 515 of articulated linkage connecting back section 51 to support structure 10
515 first and second arms of articulated linkage connecting back section 51 to support structure 10
516 articulations between support structure 10 and arms 515 of articulated linkage connecting back section 51 to support structure 10 (first) actuating mechanism adapted to raise or lower reclinable back section 51 with respect to the support structure 10
610 actuator of actuating mechanism 61 connected to reclinable back section 51 via coupling 505
62 (second) actuating mechanism adapted to raise or lower actuatable leg section 53/54 with respect to the support structure 10
620 (first) actuator of actuating mechanism 62 connected to reclinable thigh section 53 via coupling 504
625 (second) actuator of actuating mechanism 62 connected to reclinable lower-leg section 54 via articulated guide 503
FL floor
α angle of inclination of reclinable thigh section 53 with respect to support structure 10
β angle of inclination of reclinable back section 51 with respect to support structure 10
θ angle of inclination of support structure 10 with respect to floor FL

1-27. (canceled)

28. A bed comprising a support structure and an actuatable mattress support platform intended to receive a mattress and mounted on the support structure, which actuatable mattress support platform comprises a reclinable back section and an actuatable leg section,
wherein the actuatable leg section includes a reclinable thigh section and a reclinable lower-leg section that are adapted to move in conjunction with one another,
wherein the bed further comprises a first actuating mechanism adapted to raise or lower the reclinable back section with respect to the support structure, a second actuating mechanism adapted to raise or lower the actuatable leg section with respect to the support structure, and a control unit in operative communication with the first and second actuating mechanisms to adjust a configuration of the actuatable mattress support platform,
wherein the control unit is adapted to control operation of the first and second actuating mechanisms to change the configuration of the actuatable mattress support platform from a substantially flat configuration to a sitting configuration, or vice versa,
and wherein the control unit is adapted to change the configuration of the actuatable mattress support platform from the substantially flat configuration to the sitting configuration in accordance with the following sequence of actuation phases:
a first actuation phase during which the control unit operates exclusively the second actuating mechanism to raise the actuatable leg section with respect to the support structure, thereby bringing the actuatable leg section to a first intermediate position with respect to the support structure;
a second actuation phase during which the control unit operates both the first and second actuating mechanisms to respectively raise the reclinable back section and raise further the actuatable leg section with respect to the support structure, thereby bringing the actuatable leg section to a second intermediate position with respect to the support structure higher than the first intermediate position; and
a third actuation phase during which the control unit operates both the first and second actuating mechanisms to respectively raise further the reclinable back section and lower the actuatable leg section with respect to the support structure, thereby bringing the reclinable back section and actuatable leg section to selected final positions with respect to the support structure in which the reclinable back section and the actuatable leg section are both raised with respect to the support structure.

29. The bed according to claim 28, further comprising a third actuating mechanism in operative communication with the control unit and adapted to change an angle of inclination of the support structure, and thus of the actuatable mattress support platform as a whole,
wherein the control unit is further adapted, upon changing the configuration of the actuatable mattress support platform from the substantially flat configuration to the sitting configuration, to operate the third actuating mechanism to incline the support structure forward and bring the actuatable mattress support platform to a reverse Trendelenburg sitting position.

30. The bed according to claim 29, wherein the control unit is adapted to bring the actuatable mattress support platform to the reverse Trendelenburg sitting position once the actuatable leg section has been brought to the selected final position with respect to the support structure.

31. The bed according to claim 29, wherein the bed is designed in such a way that an axis of inclination of the support structure is located in the vicinity of a head portion of the bed.

32. The bed according to claim 28, wherein the reclinable back section is designed as a separate section that is independent from other sections of the actuatable mattress support platform.

33. The bed according to claim 32, wherein the reclinable back section is movable towards or away from the other sections of the actuatable mattress support platform,
wherein the control unit is adapted to operate the first actuating mechanism, during the second and third actuation phases, in such a way that a proximal end of the reclinable back section is moved away from the other sections of the actuatable mattress support platform as the reclinable back section is being raised.

34. The bed according to claim 33, wherein the reclinable back section is articulated at one end on the support structure via an articulated linkage and wherein the first actuating mechanism comprises an actuator connected to the reclinable back section via a coupling to change an angle of inclination of the reclinable back section with respect to the support structure and to move the proximal end of the reclinable back section towards or away from the other sections of the actuatable mattress support platform.

35. The bed according to claim 28, wherein the reclinable thigh section is articulated onto the support structure.

36. The bed according to claim 35, wherein the actuatable mattress support platform further includes a buttocks section, which buttocks section is fixedly secured onto the support structure or forms an integral part of the support structure.

37. The bed according to claim 28, wherein the reclinable lower-leg section is articulated onto the thigh section,
and wherein the actuatable leg section comprises an articulated guide provided on a portion of the lower-leg section, which articulated guide is adapted to slide along the support structure upon raising or lowering the actuatable leg section.

38. The bed according to claim 28, wherein the first intermediate position of the actuatable leg section is a position in which an angle of inclination of the reclinable thigh section with respect to the support structure is increased to an angle of approximately 20° to 30°,
wherein the second intermediate position of the actuatable leg section is a position in which the angle of inclination of the reclinable thigh section with respect to the support structure is increased to an angle of approximately 45° to 55°,
and wherein the final position of the actuatable leg section is a position in which the angle of inclination of the reclinable thigh section with respect to the support structure is decreased to an angle of approximately 30° to 40°.

39. The bed according to claim 38, wherein the final position of the reclinable back section is a position in which an angle of inclination of the reclinable back section with respect to the support structure is increased to an angle of approximately 45° to 55°.

40. The bed according to claim 39, wherein the final position of the reclinable back section is a position in which the angle of inclination of the reclinable back section with respect to the support structure is of the order of 50°.

41. The bed according to claim 38, wherein the first intermediate position of the actuatable leg section is a position in which the angle of inclination of the reclinable thigh section with respect to the support structure is of the order of 25°.

42. The bed according to claim 38, wherein the second intermediate position of the actuatable leg section is a position in which the angle of inclination of the reclinable thigh section with respect to the support structure is of the order of 49°.

43. The bed according to claim 38, wherein the final position of the actuatable leg section is a position in which the angle of inclination of the reclinable thigh section with respect to the support structure is of the order of 35°.

44. A method of actuating a bed comprising a support structure and an actuatable mattress support platform intended to receive a mattress and mounted on the support structure, which actuatable mattress support platform comprises a reclinable back section and an actuatable leg section,
wherein the actuatable leg section includes a reclinable thigh section and a reclinable lower-leg section that are adapted to move in conjunction with one another,
the method comprising actuating the reclinable back section and actuatable leg section to adjust a configuration of the actuatable mattress support platform and change the configuration of the actuatable mattress support platform from a substantially flat configuration to a sitting configuration, or vice versa,
and wherein the method comprises actuating the reclinable back section and actuatable leg section, upon changing the configuration of the actuatable mattress support platform from the substantially flat configuration to the sitting configuration, in accordance with the following sequence of actuation phases:
a first actuation phase during which exclusively the actuatable leg section is actuated to raise the actuatable leg section with respect to the support structure, thereby bringing the actuatable leg section to a first intermediate position with respect to the support structure;
a second actuation phase during which both the reclinable back section and the actuatable leg section are actuated to respectively raise the reclinable back section and raise further the actuatable leg section with respect to the support structure, thereby bringing the actuatable leg section to a second intermediate position with respect to the support structure higher than the first intermediate position; and
a third actuation phase during which both the reclinable back section and the actuatable leg section are actuated to respectively raise further the reclinable back section and lower the actuatable leg section with respect to the support structure, thereby bringing the reclinable back section and actuatable leg section to selected final positions with respect to the support structure in which the reclinable back section and the actuatable leg section are both raised with respect to the support structure.

45. The method according to claim 44, further comprising the step of actuating the support structure to change an angle of inclination of the support structure, and thus of the actuatable mattress support platform as a whole,
wherein the support structure is actuated, upon changing the configuration of the actuatable mattress support platform from the substantially flat configuration to the sitting configuration, to incline the support structure forward and bring the actuatable mattress support platform to a reverse Trendelenburg sitting position.

46. The method according to claim 45, wherein the actuatable mattress support platform is brought to the reverse Trendelenburg sitting position once the actuatable leg section has been brought to the selected final position with respect to the support structure.

47. The method according to claim 45, wherein actuation of the support structure is such that an axis of inclination of the support structure is located in the vicinity of a head portion of the bed.

48. The method according to claim 44, wherein actuation of the reclinable back section includes changing an angle of inclination of the reclinable back section with respect to the support structure as well as moving the reclinable back section towards or away from other sections of the actuatable mattress support platform,
and wherein a proximal end of the reclinable back section is moved away from the other sections of the actuatable mattress support platform during the second and third actuating phases as the reclinable back section is being raised.

49. The method according to claim 44, wherein the first intermediate position of the actuatable leg section is a position in which an angle of inclination of the reclinable thigh section with respect to the support structure is increased to an angle of approximately 20° to 30°,
wherein the second intermediate position of the actuatable leg section is a position in which the angle of inclination of the reclinable thigh section with respect to the support structure is increased to an angle of approximately 45° to 55°,
and wherein the final position of the actuatable leg section is a position in which the angle of inclination of the reclinable thigh section with respect to the support structure is decreased to an angle of approximately 30° to 40°.

50. The method according to claim 49, wherein the final position of the reclinable back section is a position in which an angle of inclination of the reclinable back section with respect to the support structure is increased to an angle of approximately 45° to 55°.

51. The method according to claim 50, wherein the final position of the reclinable back section is a position in which the angle of inclination of the reclinable back section with respect to the support structure is of the order of 50°.

52. The method according to claim 49, wherein the first intermediate position of the actuatable leg section is a position in which the angle of inclination of the reclinable thigh section with respect to the support structure is of the order of 25°.

53. The method according to claim 49, wherein the second intermediate position of the actuatable leg section is a position in which the angle of inclination of the reclinable thigh section with respect to the support structure is of the order of 49°.

54. The method according to claim 49, wherein the final position of the actuatable leg section is a position in which the angle of inclination of the reclinable thigh section with respect to the support structure is of the order of 35°.
